(19) United States
(12) Patent Application Publication
(10) Pub. No.: US 2024/0279944 A1
(43) Pub. Date: Aug. 22, 2024

(54) HATCH FOR CAPSULE UNIT

(71) Applicant: NINE HOURS, INC., Chiyoda-ku, Tokyo (JP)

(72) Inventors: Yugo HIRAI, Iwata-shi, Shizouka (JP); Yusuke ASHIDA, Iwata-shi, Shizouka (JP); Takayuki SUSAKI, Iwata-shi, Shizouka (JP); Jun KOMINE, Iwata-shi, Shizouka (JP); Katsuya AONUMA, Iwata-shi, Shizouka (JP)

(21) Appl. No.: 18/293,389

(22) PCT Filed: Jul. 22, 2022
(86) PCT No.: PCT/JP2022/028436

§ 371 Date: Mar. 6, 2024

(30) Foreign Application Priority Data
Jul. 30, 2021 (JP) 2021-126088

(51) Int. Cl. E04H 1/12; E06B 5/20

(52) U.S. Cl. CPC E04H 1/12; E06B 5/20

(57) ABSTRACT

Provided is a hatch for a capsule unit which opens and closes an opening of a capsule unit for sleeping. The hatch comprises: one plate-shaped member configured to cover the whole of the opening; and an inward opening mechanism that supports the plate-shaped member so as to be movable between a position at which the plate-shaped member is accommodated inside the capsule unit so that the opening is in an open state and a position at which the plate-shaped member covers the whole of the opening so that the opening is in a closed state.

### TECHNICAL FIELD

The present invention relates to a capsule unit hatch for sleep.

### BACKGROUND ART

Japanese Unexamined Patent Application Publication No. S62-21966 (Patent Document 1) discloses a bedding house for sleeping. The bedding house includes: a head-side fixed wall plate, a foot-side fixed wall plate, and a lateral fixed wall plate which are integrally formed; a collapsible lateral door and a top plate which are provided on all or a part of the ceiling and the lateral side; and an air conditioner. As the collapsible lateral door and the top plate, a louver door, an accordion door, and a flip-up door are disclosed.

The capsule bed disclosed in Japanese Unexamined Patent Application Publication No. H05-248107 (Patent Document 2) includes a capsule bed main body having a shape of a horizontally long hollow box and allowing a person to enter and exit for sleep therein, and an acoustic device and a room light which are set inside the capsule bed main body. The front end of the capsule bed body includes an entrance/exit port which is provided by cutting and through which a person can enter/exit. A roll blind is attached to a ceiling portion near the inside of the entrance and exit of the front end, and the entrance/exit port can be opened and closed from the inside by raising and lowering the roll blind.

### CITATION LIST

### Patent Document

Patent Document 1: Japanese Unexamined Patent Application, Publication No. 562-21966
Patent Document 2: Japanese Unexamined Patent Application, Publication No. H05-248107

### DISCLOSURE OF THE INVENTION

### Problems to be Solved by the Invention

The entrance/exit port of a conventional capsule unit for sleep is opened and closed by a roll blind (roll curtain). The roll blind serves as a blindfold but does not block sound. For this reason, a person who attempts to sleep in the capsule unit may be disturbed by snoring of other sleepers or sounds made by other people.

The inventors of the present invention studied an opening/closing means for an entrance/exit port in order to enhance the sound insulating property of a capsule unit for sleeping. In order to enhance the sound insulating property, a door that can completely seal the entrance/exit port was studied. However, the capsule unit is used often in a limited space. Therefore, it was found that, when a heavy opening door was installed to obtain sound insulation, the opening and closing operability was deteriorated. For example, it is assumed that the operation of opening the door becomes difficult in a narrow space, or that the door tends to hit a person or an object outside when the door is opened.

In view of the above, the present application discloses a capsule unit hatch having a high sound insulating property and a high opening and closing operability.

### Means for Solving the Problems

A capsule unit hatch according to embodiments of the present invention is a capsule unit hatch that opens and closes an opening of a capsule unit for sleeping. The capsule unit hatch includes a plate-shaped member that covers the entirety of the opening, and an inward opening mechanism that movably supports the plate-shaped member between a position at which the plate-shaped member is accommodated inside the capsule unit and the opening is opened and a position at which the plate-shaped member covers the entirety of the opening and the opening is closed.

### Effects of the Invention

According to the present disclosure, it is possible to provide a capsule unit hatch having a high sound insulating property and a high opening and closing operability.

### BRIEF DESCRIPTION OF THE DRAWINGS

FIG. 1 is a perspective view showing a configuration example of a capsule unit for sleep including a hatch according to an embodiment of the present disclosure.

FIGS. 2A-FIG. 2F are diagrams showing a configuration example of a hatch 1 shown in FIG. 1.

FIG. 3 is a diagram showing an example of a state in which a plate-shaped member 10 is locked at a closed position P2.

FIG. 4 is a diagram showing an example of a state in which the plate-shaped member 10 is locked at an open position P1.

FIG. 5 is a cross-sectional view taken along the line A-A in FIG. 2A.

FIG. 6 is a diagram showing a configuration example of a frame member and a core member of the plate-shaped member shown in FIG. 2A to FIG. 2F and FIG. 5.

FIG. 7 is a view showing a modified example of the plate-shaped member 10.

FIG. 8 is a view showing another modified example of the plate-shaped member 10.

FIG. 9 is a view showing a modified example of an inward opening mechanism.

FIG. 10 is a view showing another modified example of the inward opening mechanism.

### PREFERRED MODE FOR CARRYING OUT THE INVENTION

A capsule unit hatch according to embodiments of the present invention is a capsule unit hatch that opens and closes an opening of the capsule unit for sleeping. The capsule unit hatch includes one plate-shaped member that covers the entirety of the opening, and an inward opening mechanism that movably supports the plate-shaped member between a position in which the plate-shaped member is accommodated inside the capsule unit and the opening is opened and a position in which the plate-shaped member covers the entirety of the opening, and the opening is closed.

According to the above configuration, since the capsule unit hatch covers the entirety of the opening with one plate-shaped member, the sound insulating property is enhanced in a state where the opening is closed. Further, the inward opening mechanism allows the plate-shaped member to move to the inside of the capsule unit from the state in which the plate-shaped member covers the opening, such that the opening is opened. With such a configuration, when operating to open the opening, the plate-shaped member does not hit a person or an object outside the opening. Therefore, the opening and closing operation of the hatch is facilitated. With such a configuration, a capsule unit hatch having a high sound insulating property and a high opening and closing operability is provided.

The inward opening mechanism may be configured such that the plate-shaped member is movable between a position in which the opening is closed and a position in which the opening is opened while rotating the plate-shaped member about an axis parallel to a plate surface of the plate-shaped member. That is, the inward opening mechanism may movably support the plate-shaped member such that a normal direction of a plate surface of the plate-shaped member in a state where the plate-shaped member is accommodated inside the capsule unit and the opening is opened is different from a normal direction of the plate surface of the plate-shaped member in a state where the plate-shaped member covers the entirety of the opening and the opening is closed.

Examples of the inward opening mechanism include a hinge, a rail, a guide, or other support members. Examples of other support members include a pair of support members having one end rotatably attached to the capsule unit and the other end rotatably supporting the plate-shaped member.

The plate-shaped member may include a cushioning material provided at a position corresponding to an edge of the opening of the plate-shaped member in a state of covering the entirety of the opening. In other words, the cushioning material may be provided in a region including a position overlapping an edge of the opening in the plate-shaped member in a state of covering the entirety of the opening when viewed from a direction perpendicular to the surface of the capsule unit in which the opening is provided. This makes it difficult to generate a gap between the hatch and the edge of the opening in a state where the opening is closed by the hatch. As a result, it is possible to further enhance the sound insulating property. In addition, it is possible to mitigate a shock when a hatch hits an object or a person.

The cushioning material may be provided over the entire edge (overall circumference) of the opening. Here, the mode in which the cushioning material is provided over the entire edge of the opening includes not only the case in which the cushioning material is provided over the entire edge of the opening strictly, but also cases in which the cushioning material is considered to be provided over the entire edge from the viewpoint of sound insulating properties, even if the cushioning material is partially broken. The cushioning material may not be in direct contact with the edge of the opening.

The cushioning material may be provided not only at the edge of the opening, but also at a position corresponding to the entirety of the opening. This makes it possible to further enhance the sound insulating property. Further, the cushioning material may be provided over the entire plate-shaped member. This makes it possible to further enhance the sound insulating property and shock mitigation effect. Here, the position corresponding to the entirety of the opening and the entirety of the plate-shaped member may be strictly the entirety and may be regarded as substantially the entirety from the viewpoint of the effect.

For example, the plate-shaped member may have a plate-shaped core member, and the cushioning material may be provided so as to overlap the plate surface of the core member. In this case, the cushioning material may be provided on the outer surface of the core member. This makes it possible to further enhance the sound insulating property in a state in which the plate-shaped member covers the entirety of the opening. Further, the cushioning material may be provided on the inner surface of the core member. Thus, the shock when the plate-shaped member hits a person or an object in the capsule is mitigated. The cushioning material may be provided on both the outer surface and the inner surface of the core member. Here, the outer surface refers to a surface facing the outside of the capsule unit in a closed state in which the plate-shaped member covers the entirety of the opening, and the opening is closed. The inner surface refers to a surface opposite to the outer surface, i.e. the surface facing the inside of the capsule unit in the closed state.

The plate-shaped member may include a frame member including a plurality of elongated members extending in the in-plane direction of the plate of the plate-shaped member. This makes it possible to provide the hatch with moderate rigidity without significantly increasing the weight of the hatch. As a result, it is possible to further enhance the opening and closing operability of the hatch.

The in-plane direction of the plate of the plate-shaped member refers to a direction perpendicular to the thickness direction of the plate-shaped member. The in-plane direction of the plate of the plate-shaped member includes the up-down direction (vertical direction) and the left-right direction (horizontal or lateral direction) when the plate-shaped member covering the opening is viewed in the thickness direction of the plate-shaped member. For example, the frame member may include a vertical member extending in the up-down direction (vertical direction) and a horizontal member extending in the left-right direction (horizontal or lateral direction). The elongated member constituting the frame member is made of metal, for example. The cross-sectional shape of the elongated member may be, for example, a closed cross section, a U-shaped cross section, or an L-shaped cross section. This makes it possible to realize a skeletal member which is reduced in weight and less likely to be bent.

The inward opening mechanism may be a hinge rotatably supporting the plate-shaped member. The frame member may be connected to the hinge. This makes it difficult for the hatch to bend during opening and closing of the hatch. Therefore, the opening and closing operability can be further enhanced.

When the frame member is connected to the hinge, the frame member may be directly connected to the hinge, or the frame member may be indirectly connected to the hinge via a transmission member that transmits movement of the hinge. The transmission member is rigid enough to transmit the movement of the hinge to the frame member without bending.

The inward opening mechanism may be configured to rotatably support the plate-shaped member about one of a horizontal axis positioned above the opening or a vertical axis positioned at a lateral side of the opening. This makes it easier to accommodate the plate-shaped member along the ceiling or the side wall in the capsule with the hatch open. This makes it difficult for the hatch in the open state to interfere with the human range of motion range in the space within the capsule. Therefore, it is possible to further enhance the opening and closing operability. The inward opening mechanism is not limited thereto and may be configured to rotatably support the plate-shaped member about a horizontal axis positioned below the opening.

For example, the inward opening mechanism may include a force applicator that applies to the plate-shaped member a force to rotatably support the plate-shaped member about a horizontal axis positioned above the opening, and to rotate the plate-shaped member in a direction toward a position where the plate-shaped member is accommodated inside the capsule unit and the opening is opened. With such a configuration, when the plate-shaped member is accommodated inside the capsule unit and the opening is opened, the plate-shaped member can be prevented from rotating in a direction of closing the opening due to weight or the like.

The inward opening mechanism may include a force applicator that applies to the plate-shaped member a force to move the plate-shaped member in a direction in which the plate-shaped member moves to a position where the plate-shaped member is accommodated inside the capsule unit and the opening is opened. The plate-shaped member may include a closed state locking member that locks the plate-shaped member with respect to the opening at a position where the plate-shaped member covers the entirety of the opening, and the opening is closed. With such a configuration, in an open state in which the plate-shaped member is accommodated in the capsule unit and the opening is open, it is possible to suppress the plate-shaped member from moving in a direction in which the opening is closed by an unintended external force such as gravity. Further, it is possible for the closed state locking member to stabilize the closed state in which the opening is closed by the plate-shaped member. Therefore, it is possible to further enhance the sound insulating property and the opening and closing operability.

The plate-shaped member may include an open state locking member that locks the plate-shaped member with respect to the capsule unit at a position where the plate-shaped member is accommodated inside the capsule unit and the opening is open. With such a configuration, the open state of the hatch is stabilized.

Further, the inward opening mechanism may include a force applicator that applies a force to the plate-shaped member to move the plate-shaped member in a direction in which the plate-shaped member covers the entirety of the opening and the opening is closed. In this case, by combining with the open state locking member, the open state of the hatch is stabilized, and the hatch can be opened with a small force.

Examples of the open state locking member and the closed state locking member may include a member that is locked by magnetic force or a member that is mechanically locked such as a latch and a recessed portion.

The force applicator of the inward opening mechanism is provided between the plate-shaped member and the capsule unit. The force applicator may be configured to apply a rotational force to the plate-shaped member rotatably supported by the inward opening mechanism. Examples of the force applicator may include a gas spring, a leaf spring, a coil spring, an elastic member, a gas damper, a stay, or a member for applying a force (for example, a frictional force) to the rotation of the hinge. The force applicator may apply a force that resists the external force to the plate-shaped member when gravity, wind force, human operation force, or other external force is applied to the plate-shaped member.

The plate-shaped member may include a foldable portion. The plate-shaped member may be configured such that a portion of the opening is opened by folding back the foldable portion in a state where the plate-shaped member covers the entirety of the opening. This makes it possible to open a portion of the opening in a state in which the hatch is closed by the plate-shaped member.

Hereinafter, an electric assist bicycle according to an embodiment of the present invention will be described with reference to the accompanying drawings. In the drawings, the same or corresponding parts are denoted by the same reference numerals, and the description of the members will not be repeated.

### EMBODIMENTS

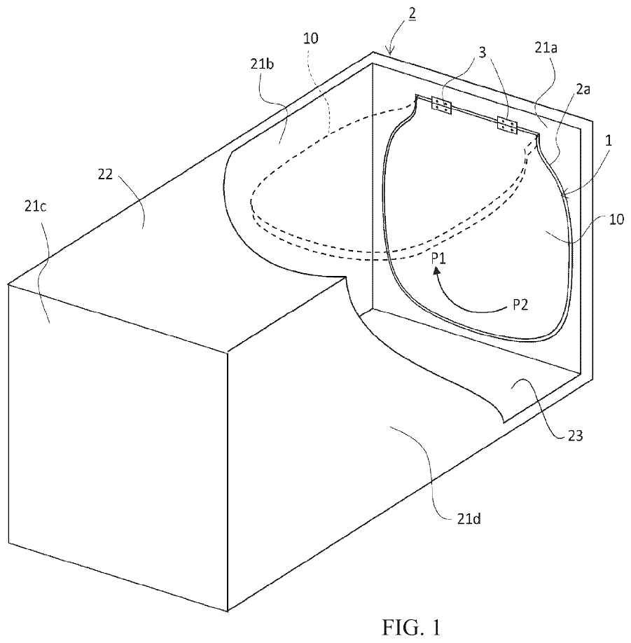

FIG. 1 is a perspective view showing a configuration example of a capsule unit for sleep including a hatch according to an embodiment of the present invention. FIG. 1 is a partial perspective view of a capsule unit in order to illustrate the configuration of a hatch. The capsule unit 2 includes a floor 23, a ceiling 22, and side walls 21a to 21d. The side walls 21a to 21d are provided at positions surrounding the side of the space between the floor 23 and the ceiling 22. The space surrounded by the floor 23, the ceiling 22, and the side walls 21a to 21d has a volume that allows a person to lie down. The side walls 21a to 21d includes an opening 2a provided at a portion thereof. A hatch 1 for opening and closing the opening 2a is attached to the capsule unit 2.

The hatch 1 includes one plate-shaped member 10 that covers the entirety of the opening and an inward opening mechanism 3. The inward opening mechanism 3 supports the plate-shaped member 10 so as to be movable while rotating between an open position P1 and a closed position P2. The open position P1 refers to a position where the plate-shaped member 10 is accommodated inside the capsule unit 2 and the opening 2a is opened. That is, the position of the plate-shaped member 10 that opens the opening 2a refers to the open position P1. The closed position P2 refers to a position where the plate-shaped member 10 covers the entirety of the opening 2a and the opening 2a is closed. That is, the position of the plate-shaped member 10 that closes the opening 2a refers to the closed position P2. FIG. 1 shows an example in which the inward opening mechanism 3 is a hinge.

The hatch 1 includes a configuration in which the entirety of the opening 2a is closed by one plate-shaped member 10, and the opening 2a is opened by rotating one plate-shaped member 10 by the inward opening mechanism 3 and accommodating the plate-shaped member 10 in the interior of the capsule unit 2. With such a configuration, it is possible to ensure the sound insulating property when the hatch 1 is closed and the opening and closing operability of the hatch 1. On the other hand, for example, in a case where the hatch 1 includes two plate-shaped members capable of gatefold opening, a gap is likely to be generated between the two plate-shaped members. Therefore, it is difficult to ensure the sound insulating property. Further, when the hatch 1 includes an outward opening plate-shaped member, there is a possibility that an object or a person outside the capsule unit 2 interferes with the plate-shaped member. Therefore, it is difficult to ensure the opening and closing operability.

In the example of FIG. 1, the inward opening mechanism 3 supports the plate-shaped member 10 rotatably around a horizontal axis positioned above the opening 2a. That is, the upper portion of the plate-shaped member 10 is rotatably supported by the inward opening mechanism 3 above the opening 2a. With this configuration, the opening and closing operation can be easily performed from both the inside and outside of the capsule unit 2. Further, when the hatch 1 is opened, the plate-shaped member 10 is accommodated in the vicinity of the ceiling 22. Therefore, it becomes difficult for a person in the capsule unit 2 to interfere with the plate-shaped member 10. That is, the plate-shaped member 10 in the open position P1 does not compress the room space of the capsule unit 2. In the example of FIG. 1, hinges of the inward opening mechanism 3 reattached between the upper portion of the plate-shaped member 10 and the side wall 21a around the opening 2a. The axis of rotation of the hinge is horizontal.

The inward opening mechanism 3 is not limited to the example shown in FIG. 1. For example, the inward opening mechanism 3 may rotatably support the plate-shaped member 10 about a vertical axis positioned on a lateral side of the opening 2a. In this case, when the hatch 1 is opened, the plate-shaped member 10 is accommodated in the vicinity of the side wall 21b or 21d. Further, at the time of opening and closing, since the plate-shaped member 10 rotates about the axis in the vertical direction, the feeling of opening and closing operation becomes light regardless of the weight of the plate-shaped member 10.

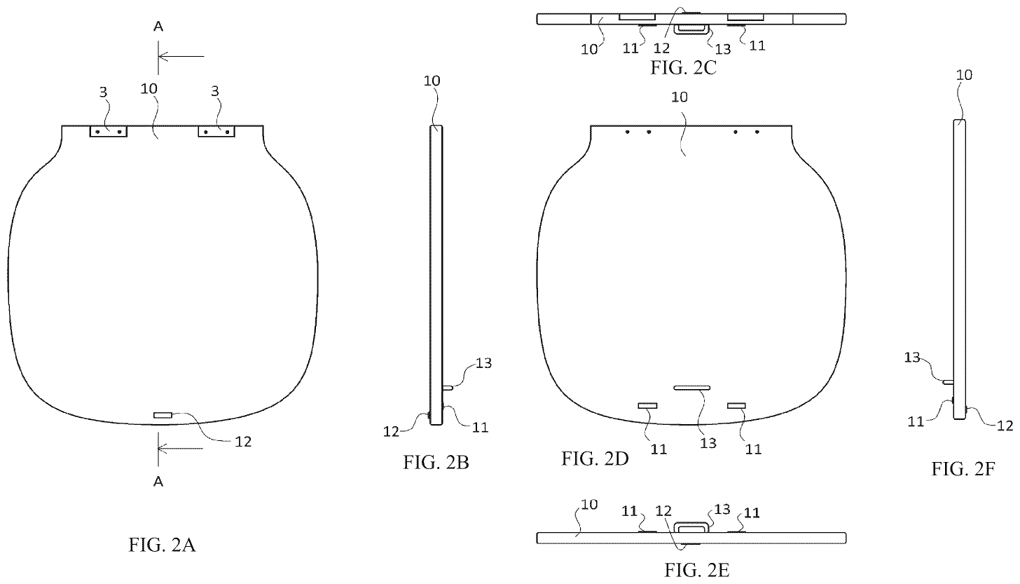

FIG. 2A to FIG. 2F is a diagram showing a configuration example of the hatch 1 shown in FIG. 1. FIG. 2A is a front view of the hatch 1. FIG. 2B is a right side view.

FIG. 2C is a top view. FIG. 2D is a rear view. FIG. 2E is a bottom view. FIG. 2F is a left side view. Here, the front view of the hatch 1 is referred to as a view in which the hatch 1 in which the opening 2a is closed is seen from the outside of the capsule unit 2 in a direction perpendicular to the surface of the side wall 21a provided with the opening 2a.

As shown in FIGS. 2A-FIG. 2F, the hatch 1 includes the plate-shaped member 10 and the inward opening mechanism 3. The plate-shaped member 10 is a plate-shaped rigid body. The plate shape refers to a shape having a larger dimension in the width direction (vertical and horizontal) than the thickness. The plate-shaped member 10 is attached to the capsule unit 2 in a state of being rotatable about one axis parallel to the plate surface of the plate-shaped member by the inward opening mechanism 3. When the plate-shaped member 10 rotates with respect to the capsule unit 2, the opening 2a is opened and closed.

In the example shown in FIGS. 2A-FIG. 2F, the hinges serving as the inward opening mechanism 3 are attached to the end of the plate-shaped member 10. As shown in FIG. 2A, the side of the plate-shaped member 10 to which the hinges are attached is a straight line parallel to the rotation axis of the hinge. The rotation axis of the hinges serves as a rotation axis of the plate-shaped member 10. In addition, in FIG. 2A, only portions of the plate-shaped member 10 to which the hinges are attached are shown, and portions of the hinges attached to the capsule unit 2 are not shown. In FIGS. 2B to 2F, illustration of the hinges is omitted.

Open state locking members 11 are provided on the rear surface of the plate-shaped member 10, i.e., the surface positioned on the indoor side in a state in which the opening 2a is closed (hereinafter, this surface may be referred to as an inner surface). The open state locking member 11 holds the plate-shaped member 10 in the open position P1. The plate-shaped member 10 is locked with respect to the capsule unit 2 by the open state locking member 11 in the open position P1. The open state locking member 11 exhibits a locking effect by being combined with a corresponding locking member provided in the capsule unit 2. In the example shown in FIGS. 2A-FIG. 2F, the open state locking member 11 holds the state in which the plate-shaped member 10 is in the open position P1 by the magnetic force. The open state locking member 11 includes, for example, a magnet or a material that sticks to the magnet, i.e., a ferromagnetic material. One of the open state locking member 11 and the corresponding locking member of the capsule unit 2 may be a magnet and the other may be a material that sticks to the magnet. The magnet may be a permanent magnet or an electromagnet. The material that sticks to the magnet may be, for example, a soft magnetic material.

A closed-state locking member 12 is provided on the front surface of the plate-shaped member 10, i.e., a surface positioned on the outdoor side in a state where the opening 2a is closed (hereinafter, this surface may be referred to as an outer surface). The closed state locking member 12 holds the plate-shaped member 10 in the closed position P2. The plate-shaped member 10 is locked with respect to the capsule unit 2 by the closed state locking member 12 in the closed position P2. The closed state locking member 12 exhibits a locking effect by being combined with a corresponding locking member provided in the capsule unit 2. In the example shown in FIGS. 2A-FIG. 2F, the closed state locking member 12 holds the state in which the plate-shaped member 10 is in the closed position P2 by the magnetic force.

A handle 13 is provided on the rear surface, i.e., the inner surface of the plate-shaped member 10. The handle 13 facilitates opening and closing operability. In addition, the handle 13 may be provided on at least one of the front surface and the rear surface (i.e., the outer surface and the inner surface) of the plate-shaped member 10. Further, the handle 13 may be omitted. As shown in FIGS. 2A-FIG. 2F, the handle 13 is not limited to a shape protruding from the surface of the plate-shaped member 10. For example, a recess may be provided on the surface of the plate-shaped member 10, and the recess may be used as the handle 13. Alternatively, the handle 13 may be a string, a band (belt) attached to the plate-shaped member 10, or a ring of these.

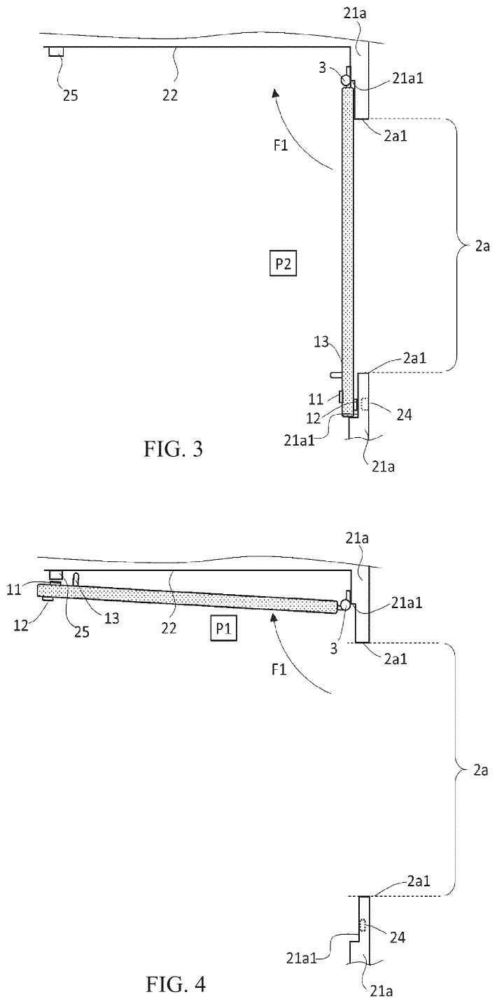

FIG. 3 is a diagram showing an example of a state in which the plate-shaped member 10 is locked in the closed position P2. FIG. 4 is a diagram showing an example of a state in which the plate-shaped member 10 is locked in the open position P1. In the example shown in FIG. 3, the plate-shaped member 10 covers the entirety of the opening 2a in the closed position P2. In the closed position P2, the plate surface of the plate-shaped member 10 is substantially parallel to the surface of the side wall 21a provided with the opening 2a. In the closed position P2, the plate-shaped member 10 comes into contact with the side wall 21a at least partially around the opening 2a. This makes it possible to further enhance the sound insulating property. From the viewpoint of sound insulating properties, it is preferable that the plate-shaped member 10 is in contact with the side wall 21a over the entire periphery of the opening 2a. In the example of FIG. 3, the closed state locking member 12 protrudes from the surface of the plate-shaped member 10. However, the surface of the closed state locking member 12 may be provided on the same plane with the surface of the plate-shaped member 10, i.e., flush with the surface of the plate-shaped member 10. Outside the edge 2a1 of the opening 2a, the plate-shaped member 10 is locked with respect to the side wall 21a by the locking member 24 provided, for example, in the side wall 21a and the closed state locking member 12 of the plate-shaped member 10. The locking member 24 is provided at a position corresponding to the closed state locking member 12 of the plate-shaped member 10 in the closed position P2. The surface of the locking member 24 may be provided on the same plane with the inner surface of the side wall 21a, i.e., flush with the inner surface of the side wall 21a. With such a configuration, in the closed position P2, the surface of the plate-shaped member 10 around the closed state locking member 12 is likely to contact the side wall 21a. For example, the locking member 24 and the closed state locking member 12 are attracted to each other by a magnetic force to lock the plate-shaped member 10.

In the example shown in FIG. 4, the plate-shaped member 10 is accommodated in the capsule unit 2 in the open position P1. In the open position P1, the plate-shaped member 10 is locked by the open-state locking member 11 and the locking member 25 provided on the ceiling 22, which is a portion of the capsule unit 2. In this example, in the open position P1, the plate-shaped member 10 is locked in a state along the ceiling 22 (a state in which the plate surface and the surface of the ceiling 22 are substantially parallel to each other). With such a configuration, the plate-shaped member 10 in the open position P1 is less likely to interfere with a person in the capsule unit 2. The locking member 25 is provided at a position corresponding to the open state locking member 11 of the plate-shaped member 10 in the open position P1. For example, the locking member 25 and the open-state locking member 11 are attracted to each other by a magnetic force to lock the plate-shaped member 10.

The open state locking member 11 and the closed state locking member 12 are not limited to examples using the magnetic force. At least one of the open state locking member 11 or the closed state locking member 12 may be mechanically engaged and locked with the locking member of the capsule unit 2. That is, at least one of the open state locking member 11 or the closed state locking member 12 may be a mechanism that mechanically holds the closed state or the open state. For example, one of the open state locking member 11 or the closed state locking member 12 and one of the locking members of the capsule unit 2 may have a recessed shape and a corresponding other of the open state locking member 11 or the closed state locking member 12 and a corresponding other of the locking members of the capsule unit 2 may have a protruding shape to be engaged with the recessed shape. For example, at least one of the open state locking member 11 and the closed state locking member 12 may include a latch, a hook, a rope or a depression.

In the configuration shown in FIG. 3 and FIG. 4, the inward opening mechanism 3 may include a force applicator that applies a rotating force to the plate-shaped member 10. For example, although not shown in the drawings, a shaft-shaped member that can expand and contract in the axial direction may be provided, as the force applicator, between a portion other than the rotation axis of the plate-shaped member 10 and the inner surface of the capsule unit 2. In this case, one end of the shaft-shaped member may be rotatably attached to the capsule unit 20 and the other end may be rotatably attached to the plate-shaped member 10. The rotation axis of the shaft-shaped member may be parallel to the rotation axis of the plate-shaped member 10. Examples of such a shaft-shaped member include a coil spring, other elastic members, a gas spring, a gas damper, a stay, and the like. The force applicator is not limited to a shaft-shaped member. For example, a member that generates a frictional force or the like with respect to the rotation axis of the plate-shaped member 10 such as a hinge may be used. In this case, the force applicator may generate a force that resists an external force to rotate the plate-shaped member 10.

Further, the force applicator may apply only one of a force that rotates the plate-shaped member 10 toward the open position P1 and a force that rotates the plate-shaped member 10 toward the closed position P2. For example, as indicated by an arrow F1 shown in FIGS. 3 and 4, a force applicator may be provided that applies a force to rotate the plate-shaped member 10 toward the open position P1 and not to apply a force to rotate the plate-shaped member 10 toward the closed position P2. In this case, the force applicator can prevent the plate-shaped member 10 in the open position P1 or in the vicinity of the open position P1 from rotating in the direction of closing the opening 2a by gravity. That is, unintended free falling of the plate-shaped member 10 when the opening 2a is opened can be prevented.

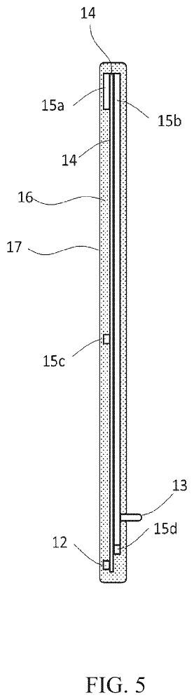

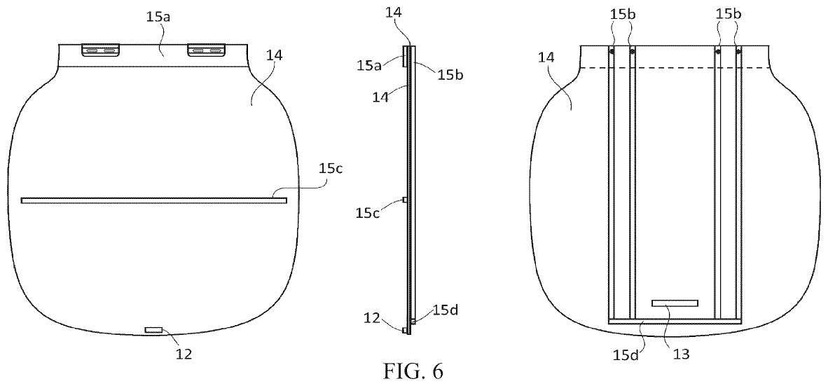

FIG. 5 is a cross-sectional view taken along the line A-A in FIG. 2A. In the example shown in FIG. 5, the plate-shaped member 10 includes frame members 15a to 15d, a core member 14, a cushioning material 16, and a surface material 17. FIG. 6 is a diagram showing a configuration example of the frame members 15a to 15d and the core member 14 of the plate-shaped member 10 shown in FIGS. 2A-FIG. 2F and FIG. 5.

The core member 14 is a plate-shaped member that extends along the surface of the plate of the plate-shaped member 10. The core member 14 is provided over substantially the entire surface of the plate surface of the plate-shaped member 10. On the inner surface of the core member 14 (a surface of the plate-shaped member 10 in the closed position P2 facing the inside of the capsule unit), a plurality of frame members 15b extending in the up-down direction (vertical direction) and a frame member 15d extending in the horizontal direction (lateral direction) are provided. The frame member 15d is in contact with the ends of the plurality of frame members 15b. On the outer surface of the core member 14 (a surface of the plate-shaped member 10 in the closed position P2 facing the outside of the capsule unit), a frame member 15a extending in the lateral direction is provided in an upper region of the plate-shaped member 10 on which the hinges 3 are provided, and a frame member 15c extending in the lateral direction is provided at the center in the up-down direction of the plate-shaped member 10. Each of the frame members 15a to 15d is an elongated member. When viewed in a direction perpendicular to the plate surface of the plate-shaped member 10, the frame members 15a to 15d are provided in a narrower range than the core member 14. The thickness of the frame members 15a to 15d is larger than the thickness of the core member 14.

The core member 14 may be made of a resin such as polyethylene (PE) or polypropylene (PP). The frame members 15a to 15d may be made of, for example, aluminum, iron, wood, or fiber reinforced resin. The frame members 15a to 15d may be tubular hollow members or elongated members each having an L-shaped cross section or a U-shaped cross section.

Since the plate-shaped member 10 includes the plate-shaped core member 14 and the plurality of elongated frame members 15a to 15d, the plate-shaped member 10 can be reduced in weight and difficult to bend. With such a configuration, the opening and closing operability of the hatch 1 can be further enhanced.

The present inventors found that, by configuring the hatch 1 by a single inward opening plate-shaped member 10, it is possible to ensure the sound insulating property and the opening and closing operability. The present inventors noted that, when the hatch 1 includes a single plate-shaped member 10, it is important to prevent the plate-shaped member 10 from bending in the opening/closing operation and in the closing position P2 from the viewpoint of sound insulation and opening and closing operability. The present inventors attempted to increase the thickness of the core member 14 to increase the rigidity of the plate-shaped member 10, thereby making the plate-shaped member 10 difficult to bend. In this case, it was found that the weight of the plate-shaped member 10 becomes heavy, and the opening and closing operability deteriorates. Accordingly, as a result of intensive investigations, the present inventors have contemplated that, by using at least one elongated frame member, it is possible to configure a single plate-shaped member 10 which is difficult to bend without increasing the thickness of the core member 14. That is, the present inventors have conceived the plate-shaped member 10 which is reduced in weight and difficult to bend.

In the plate-shaped member 10, the core member 14 may be omitted. For example, the plate-shaped member 10 may include a plurality of elongated frame members extending in the up-down direction (vertical direction), a plurality of elongated frame members extending in the left-right direction (lateral or horizontal direction), a surface material attached to these frame members, and a cushioning material filled in the surface material. In this case as well, a plate-shaped member which is reduced in weight and less likely to be bent can be obtained. Further, the frame members 15a to 15d may be provided in a wider range than the core member 14 when viewed in a direction perpendicular to the plate surface of the plate-shaped member 10.

The weight of the plate-shaped member 10 is not particularly limited, but is preferably 5.0 kg or less, more preferably 4.0 kg or less, still more preferably 3.5 kg or less, and still more preferably 3.0 kg or less from the viewpoint of opening and closing operability. The lower limit of the weight of the plate-shaped member is not particularly limited. From the viewpoint of ensuring sound insulating properties, for example, the weight of the plate-shaped member 10 may be 1.0 kg or more.

In the example shown in FIG. 5 and FIG. 6, the plurality of frame members 15b extending in the up-down direction are all connected to the hinges 3. In this example, the frame members 15b each serving as a vertical member and the frame member 15a serving as a horizontal member are fastened to the plate of the hinges 3 by fasteners. Each of the fasteners is, for example, a screw or a bolt. The connection mode is not limited to fastening. For example, instead of fastening by a fastener, the frame member 15b may be connected to the hinge 3 by welding or the like. In this way, by connecting the plurality of frame members 15b extending in the up-down direction to the hinges 3, the plate-shaped member 10 is less likely to be bent in the out-of-plane direction when the plate-shaped member 10 rotates about the hinges 3. That is, the rigidity of the plate-shaped member 10 during the opening and closing operation is ensured.

As shown in FIG. 5 and FIG. 6, the frame member 15b may be directly connected to the hinge 3 or may be indirectly connected to the hinge 3. For example, the frame member 15b may not be directly attached to the hinge 3 but may be attached to the frame member 15a connected to the hinge 3. In this case, the frame member 15b is connected to the hinge 3 using the frame member 15a as a transmission member.

In the plate-shaped member 10 shown in FIGS. 5 and 6, the cushioning material 16 encloses the frame members 15a to 15d, and the surface material 17 encloses the cushioning material 16. That is, the cushioning material 16 is filled between the frame members 15a to 15d and the surface material 17. The surface material 17 provides the outermost skin of the plate-shaped member 10. By filling the plate-shaped member 10 with the cushioning material 16 in this manner, it is possible to further enhance the sound insulating property and the opening and closing operability of the hatch 1. The cushioning material 16 is made of a material which is reduced in weight and easily deformable. The material of the cushioning material 16 is not particularly limited, but may be, for example, a resin such as urethane, a nature-originating fiber such as cotton, wool, or feather, or a synthetic fiber. The cushioning material 16 may be in the form of a sheet or tape or may be in the form of a fiber (for example, cotton). Further, for example, the cushioning material 16 may be made of a resin having air bubbles therein.

The surface material 17 may be made of synthetic leather. The surface material and the cushioning material may be integrated. For example, the cushioning material may also serve as a surface material.

In the example shown in FIG. 5 and FIG. 6, the cushioning material 16 is provided on both the outer surface and the inner surface of the core member 14. The cushioning material 16 may be provided only on either the outer surface or the inner surface of the core member 14. By providing the cushioning material 16 on the outer surface of the core member 14, the cushioning material 16 can be provided at a position in the vicinity of a portion where the plate-shaped member 10 in the closed position P2 comes into contact with the periphery of the opening 2a. Therefore, the sound insulating property can be further enhanced. On the other hand, even when the cushioning material 16 is provided on the inner surface side of the core member 14, the cushioning material 16 contributes to an improvement in sound insulating properties. In addition, the cushioning material 16 mitigates a shock when the plate-shaped member 10 comes into contact with a person or an object inside the plate-shaped member 10.

In the example shown in FIG. 5 and FIG. 6, the cushioning material 16 is provided substantially entirely on the plate-shaped member 10 when viewed in a direction perpendicular to the plate surface of the plate-shaped member 10. This makes it possible to further enhance the sound insulation performance and shock mitigation performance. In addition, the cushioning material 16 may be provided on a portion of the plate-shaped member 10 when viewed in a direction perpendicular to the plate surface. For example, the cushioning material 16 may be provided in a region including a position where the plate-shaped member 10 in the closed position P2 overlaps the edge 2al of the opening 2a when viewed in a direction perpendicular to the plate surface. Thus, since the cushioning material 16 of the plate-shaped member 10 can be provided in the vicinity of the edge 2al of the opening 2a in the closed position P2, the sound insulating property can be improved efficiently.

### Modified Example: Configuration Example 1 that is Foldable

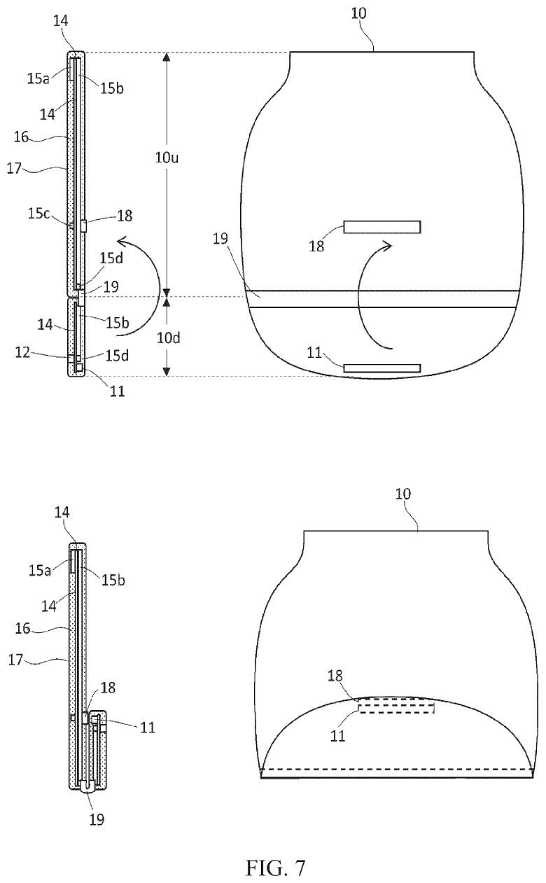

FIG. 7 is a view showing a modified example of the plate-shaped member 10. The plate-shaped member 10 shown in FIG. 7 is configured such that a portion thereof is foldable. The upper part of FIG. 7 shows a cross-sectional view and a rear view of the plate-shaped member 10 in a state in which the plate-shaped member 10 is not folded back. The lower part of FIG. 7 shows a cross-sectional view and a rear view of the plate-shaped member 10 in a state in which the plate-shaped member 10 is partially folded back.

As shown in the upper part of FIG. 7, the plate-shaped member 10 includes a foldable portion. The plate-shaped member 10 includes an upper portion 10u and a lower portion 10d which are connected to each other via an elastic member 19. The upper portion 10u and the lower portion 10d are independent plate-shaped bodies. Each of the upper portion 10u and the lower portion 10d includes the core member 14, the frame members 15b each serving as a vertical member, the frame members 15c and 15d each serving as a horizontal member, the cushioning material 16, and the surface material 17. The lower portion 10d is foldable.

With the lower surface of the upper portion 10u and the upper surface of the lower portion 10d in contact with each other, the inner surface of the upper portion 10u and the inner surface of the lower portion 10d are connected by the elastic member 19. In other words, the ridge line between the lower surface and the inner surface of the upper portion 10u and the ridge line between the upper surface and the inner surface of the lower portion 10d are connected via the elastic member. With such a configuration, the lower portion 10d is rotatable about the ridge line between the upper surface and the inner surface of the lower portion 10d with respect to the upper portion 10u. As shown in the lower part of FIG. 7, the lower portion 10d can be rotated and folded back to overlap the upper portion 10u.

The upper portion 10u includes a fold-back locking member 18 at a position overlapping the open-state locking member 11 of the lower portion 10d which has been folded back. The fold-back locking member 18 interacts with the open-state locking member 11 of the lower portion 20d which has been folded back, whereby the fold-back lower portion 10d which has been folded back is locked with the upper portion 10u. The open-state locking member 11 and the fold-back locking member 18 may be configured to attract each other by a magnetic force, for example, or may be configured to be mechanically engaged with each other.

The opening 2a is partially opened by folding the lower portion 10d, which serves as a foldable portion, in a state where the plate-shaped member 10 covers the entirety of the opening 2a in the closed position P2. Further, when the plate-shaped member 10 is rotated and moved from the closed position P2 to the open position P1 in a state in which the lower portion 10d is not folded back, the plate-shaped member 10 maintains a state in which the lower portion 10d is not folded back. This is because the inner surface of the upper portion 10u and the inner surface of the lower portion 10d are connected by the elastic member 19 in a state where the lower surface of the upper portion 10u and the upper surface of the lower portion 10d are in contact with each other. In the example shown in FIG. 7, the plate-shaped member 10 is partially foldable inwardly. As another modified example, the plate-shaped member 10 may be foldable outwardly.

### Modified Example: Configuration Example 2 that is Foldable

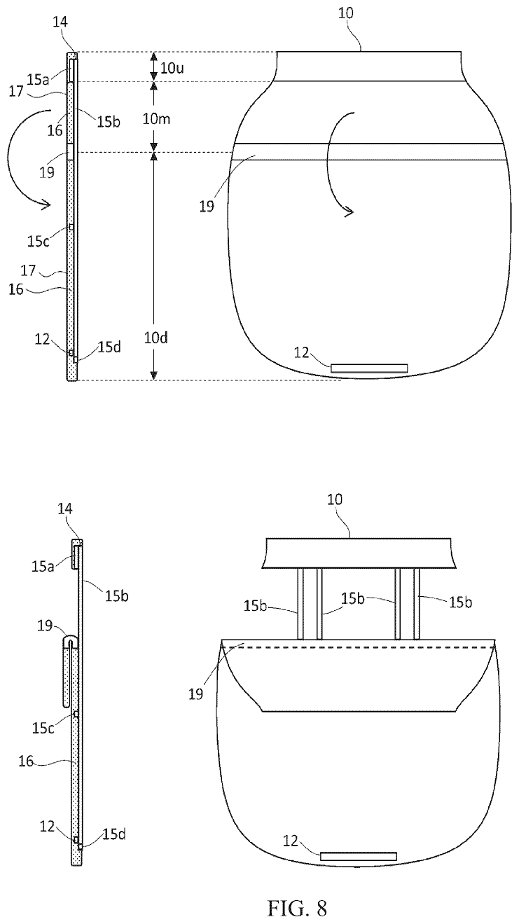

FIG. 8 is a view showing another modified example of the plate-shaped member 10. The plate-shaped member 10 shown in FIG. 8 is configured such that a portion thereof can be folded back. The upper part of FIG. 8 shows a cross-sectional view and a front view of the plate-shaped member 10 in a state in which the plate-shaped member 10 is not folded back. The lower part of FIG. 8 shows a cross-sectional view and a front view of the plate-shaped member 10 in a state in which a portion of the plate-shaped member 10 is folded back.

As shown in the upper part of FIG. 8, the plate-shaped member 10 includes an upper portion 10u, a middle portion 10m, and a lower portion 10d. The middle portion 10m is a foldable portion. The upper portion 10u, the middle portion 10m, and the lower portion 10d each have a plate-shape. None of the upper portion 10u, the middle portion 10m, and the lower portion 10d has the core member 14. The plate-shaped member 10 is configured such that a cushioning material filled in the surface material 17 is attached to the frame members 15a to 15d.

In the example of FIG. 8, the plate-shaped member 10 includes the plurality of frame members 15b extending in the up-down direction and passing through all of the upper portion 10u, the middle portion 10m, and the lower portion 10d. The frame member 15a serving as a horizontal member is connected to the frame members 15b at the upper portion 10u. Although not shown, the hinges 3 are connected to the frame members 15b, for example. The middle portion 10m includes the cushioning material and the surface material 17 enclosing the cushioning material. In this example, the middle portion 10m is connected to the lower portion 10d fixed to the frame members 15b via an elastic member 19. The middle portion 10m is not fixed to the frame members 15b. The lower portion 10d is configured such that the surface material 17 attached to the frame members 15b is filled with the cushioning material 16.

The middle portion 10m is fitted between the upper portion 10u and the lower portion 10d. The elastic force of the elastic member 19 maintains a state in which the middle portion 10m is fitted between the upper portion 10u and the lower portion 10d. As shown in the lower part of FIG. 8, when the middle portion 10m is detached from between the upper portion 10u and the lower portion 10d, the middle portion 10m can be folded back with the elastic member 19 as a boundary and can be superimposed on the lower portion 10d.

In the case of the plate-shaped member 10 being in the closed position P2, when the middle portion 10m is detached from between the upper portion 10u and the lower portion 10d, the middle portion 10m hangs down by gravity, and the middle portion 10m overlaps the lower portion 10d, as shown in the lower part of FIG. 8. The opening 2a is partially opened by folding the middle portion 10m, which serves as a foldable portion, in a state where the plate-shaped member 10 covers the entirety of the opening 2a in the closed position P2. When the plate-shaped member 10 is rotated and moved from the closed position P2 to the open position P1 in a state in which the middle portion 10m is not folded back, the plate-shaped member 10 maintains a state in which the middle portion 10m is not folded back. This is because the position of the middle portion 10m is maintained by the elastic force of the elastic member 19. In the example shown in FIG. 8, the plate-shaped member 10 is partially foldable outwardly. As another modified example, the plate-shaped member 10 may be partially foldable inwardly.

### Modified Example 1 of Inward Opening Mechanism

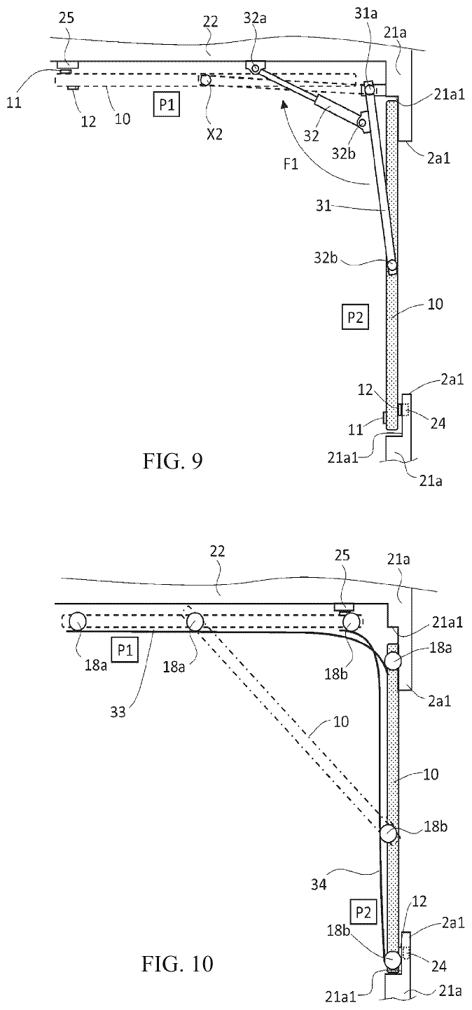

FIG. 9 is a view showing a modified example of the inward opening mechanism. In the example shown in FIG. 9, the inward opening mechanism includes an arm 31 rotatably supporting the plate-shaped member 10. The arm 31 includes one end that is rotatably connected to the capsule unit 2 and the other end that rotatably supports the plate-shaped member 10. The directions of a rotating shaft 31a at the one end of the arm 31 and a rotating shaft 31b at the other end of the arm 31 are the same. In the example of FIG. 9, the rotating shaft 31a at the one end of the arm 31 and the rotating shaft 31b at the other end of the arm 31 are both horizontal and extend in the left-right direction (lateral or horizontal direction) of the plate-shaped member 10. When the arm 31 rotates with respect to the capsule unit 2, the plate-shaped member 10 moves between the closed position P2 and the open position P1. In addition, the arm 31 may be provided in a pair on the left and right sides of the plate-shaped member 10.

In the example shown in FIG. 9, the inward opening mechanism includes a gas damper 32 serving as a force applicator. The gas damper 32 is a shaft-shaped member that can expand and contract in the axial direction. The gas damper 32 includes one end that is rotatably connected to the capsule unit 2. The gas damper 32 includes the other end that is rotatably connected between the rotating shaft 31a at the one end and the rotating shaft 31b at the other end of the arm 31. The directions of the rotating shaft 32a at the one end of the gas damper 32 and the rotating shaft 32b at the other end of the gas damper 32 are the same. Further, the directions of the rotating shafts 32a and 32b of the gas damper 32 and the rotating shafts 31a and 31b of the arm 31 are the same. In addition, the gas dampers 32 may be provided in a pair on the left and right sides of the plate-shaped member 10.

The gas damper 32 applies a rotating force to the arm 31. For example, the gas damper 32 may be configured to apply a force for rotating the arm 31 to move the plate-shaped member 10 in a direction in which the plate-shaped member 10 is moved to the open position P1. In this case, the plate-shaped member 10 in the closed position P2 is locked against the force of the gas damper 32 by the closed state locking member 12. When the locking by the closed state locking member 12 is released, the plate-shaped member 10 moves while rotating toward the open position P1 by the force of the gas damper 32. In FIG. 9, the plate-shaped member 10 in the open position P1 is indicated by a broken line. Since the plate-shaped member 10 in the open position P1 is forced by the gas damper 32, the plate-shaped member 10 does not naturally fall by gravity and does not move toward the closed position P2. In FIG. 9, the plate-shaped member 10 includes the open state locking member 11. However, the open state locking member 11 of the plate-shaped member 10 may be omitted. In FIG. 9, the inward opening mechanism 3 includes the arm 31 and the gas damper 32 connected to the arm 31. As another modified example, the arm 31 may include a member that can expand and contract in the axial direction of the gas damper 32, for example. In this case, the gas damper connected to the arm 31 is unnecessary, and the arm 31 includes a force applicator.

### Modified Example 2 of Inward Opening Mechanism

FIG. 10 is a view showing another modified example of the inward opening mechanism. In the example shown in FIG. 10, the inward opening mechanism includes a first rail 33 and a second rail 34. The plate-shaped member 10 includes a first rolling element 18a rolling along the first rail 33 and a second rolling element 18b rolling along the second rail 34. The first rolling element 18a and the second rolling element 18b are spaced apart from each other and arranged side by side in the up-down direction (vertical direction) of the plate-shaped member 10. Each of the first rail 33 and the second rail 34 may be provided in a pair on the left and right sides of the plate-shaped member 10, and each of the first rolling element 18a and the second rolling element 18b may also be provided in a pair on the left and right sides of the plate-shaped member 10. When the first rolling element 18a rolls on the first rail 33 and the second rolling element 18b rolls on the second rail 34, the plate-shaped member 10 moves between the closed position P2 and the open position P1. In addition, a similar inward opening mechanism can be realized by using, for example, a guide and a sliding member that slides and moves along the guide instead of the rail and the rolling elements that roll the rails shown in FIG. 10.

The hatch 1 in the above embodiments is a capsule unit hatch for sleep. The capsule unit has a box shape having a space within which a person can lie down. The capsule unit is installed in, for example, an accommodation facility such as a capsule hotel, or a temporary sleep facility such as a hospital, an airport, or a factory. The above embodiments can be applied as a hatch of such a capsule unit. Thus, a capsule unit hatch superior in sound insulating property and opening and closing operability is provided.

In the above embodiments, the hatch 1 is a hatch that opens and closes the opening 2a of the side wall 21a at one end of the capsule unit 2 in the depth direction (longitudinal direction). The position of the hatch 1 in the capsule unit 2 is not limited to this example. For example, the configurations of the present embodiments can be applied to a hatch which opens and closes the opening 2a of the side wall of one end of both ends in a direction perpendicular to the longitudinal direction (width direction). Alternatively, the configurations of the present embodiments can be applied to a hatch that opens and closes the opening 2a of the ceiling 22 or the floor 23.

Further, the hatch 1 is not limited to the opening 2a for a person to enter and exit. For example, the configurations of the present embodiments can be applied to a hatch for an opening other than an entrance/exit opening for a person such as a window of the capsule unit 2 or a ventilator. Further, the plate-shaped member of the hatch may be attached to the capsule unit so as not to move from the opening toward the outside of the capsule unit, as in the above examples. This makes it difficult for the plate-shaped member to interfere with a person or an object outside the capsule unit. For example, the movement range of the plate-shaped member may be limited within the capsule unit by the inward opening mechanism. Alternatively, the opening may be provided such that the edge of the opening prevents the plate-shaped member from exiting. In addition, embodiments of the present invention include a hatch in which the plate-shaped member is movable out of the capsule unit.

Although embodiments of the present invention have been described above, the embodiments described above are merely illustrative for carrying out the present invention. Accordingly, the present invention is not limited to the embodiments described above, and the embodiments described above can be appropriately modified and implemented without departing from the gist of the present invention.

### EXPLANATION OF REFERENCE NUMERALS

1: hatch
2: capsule unit
3: inward opening mechanism
10: plate-shaped member
11: closed state locking member
12: open state locking member
15: frame member
16: cushioning material

1. A capsule unit hatch that opens and closes an opening of a capsule unit for sleep, the capsule unit hatch comprising:
a plate-shaped member that covers an entirety of the opening; and
an inward opening mechanism that movably supports the plate-shaped member between a position at which the plate-shaped member is accommodated inside the capsule unit and the opening is opened and a position at which the plate-shaped member covers the entirety of the opening, and the opening is closed.

2. The capsule unit hatch according to claim 1, wherein
the plate-shaped member includes a cushioning material provided at a portion corresponding to an edge of the opening of the plate-shaped member in a state of covering the entirety of the opening.

3. The capsule unit hatch according to claim 1, wherein
the plate-shaped member includes a frame member including a plurality of elongated members extending in an in-plane direction of a plate of the plate-shaped member.

4. The capsule unit hatch according to claim 3, wherein
the inward opening mechanism is a hinge rotatably supporting the plate-shaped member, and
the frame member is connected to the hinge.

5. The capsule unit hatch according to claim 1, wherein
the inward opening mechanism is configured to rotatably support the plate-shaped member about one of a horizontal axis positioned above the opening or a vertical axis positioned at a lateral side of the opening.

6. The capsule unit hatch according to claim 1, wherein
the inward opening mechanism includes a force applicator that applies to the plate-shaped member a force to move the plate-shaped member in a direction toward a position where the plate-shaped member is accommodated inside the capsule unit and the opening is opened,
and
the plate-shaped member includes a closed state locking member that locks the plate-shaped member with respect to the opening at a position where the plate-shaped member covers the entirety of the opening, and the opening is closed.

7. The capsule unit hatch according to claim 1, wherein
the plate-shaped member includes a foldable portion, and
the opening is partially opened by folding back the foldable portion in a state where the plate-shaped member covers the entirety of the opening.
